(19) United States
(12) Patent Application Publication
(10) Pub. No.: US 2024/0128544 A1
(43) Pub. Date: Apr. 18, 2024

(54) BATTERY PACK

(71) Applicant: Prime Planet Energy & Solutions, Inc., Tokyo (JP)

(72) Inventor: Yuya MOGI, Kasai-shi (JP)

(21) Appl. No.: 18/462,412

(22) Filed: Sep. 7, 2023

(30) Foreign Application Priority Data
Oct. 13, 2022 (JP) 2022-164658

(51) Int. Cl. H01M 10/6568; H01M 10/613; H01M 50/209; H01M 50/242

(52) U.S. Cl. CPC H01M 10/6568; H01M 10/613; H01M 50/209; H01M 50/242

(57) ABSTRACT

In a stack, a plurality of battery cells are stacked along a first direction, each of the plurality of battery cells having a prismatic shape including an upper surface, a bottom surface facing the upper surface, and a side surface located between the upper surface and the bottom surface. In a housing, a bottom portion facing the bottom surface and a side wall portion facing the side surface are formed in one piece. The bottom portion includes a cooling mechanism that can cool the stack. The side wall portion includes a shock absorbing mechanism.

### CROSS REFERENCE TO RELATED APPLICATIONS

This nonprovisional application is based on Japanese Patent Application No. 2022-164658 filed on Oct. 13, 2022 with the Japan Patent Office, the entire contents of which are hereby incorporated by reference.

### BACKGROUND OF THE INVENTION

### Field of the Invention

The present technology relates to a battery pack.

### Description of the Background Art

Japanese Patent Laying-Open No. 2009-105007 is a prior art document that discloses a configuration of an electric vehicle battery tray. The electric vehicle battery tray described in Japanese Patent Laying-Open No. 2009-105007 includes a frame and a plurality of tray members. The plurality of tray members are assembled in the frame to provide an accommodation portion in which a battery is mounted. The plurality of tray members are welded and joined together. The plurality of tray members and the frame are welded and coupled together. Each of the frame and the tray members includes engagement means. Further, each of the tray members is provided with a hollow portion and may be used as a region in which a cable is routed.

The specification of Chinese Utility Model No. 208189687 is a prior art document that discloses a configuration of a battery case. The battery case described in the specification of Chinese Utility Model No. 208189687 includes a lower case. The lower case includes a lower case left bottom plate and a lower case right bottom plate. The lower case left bottom plate and the lower case right bottom plate are joined together by welding or the like.

### SUMMARY OF THE INVENTION

A housing for accommodating the battery cell as described in Japanese Patent Laying-Open No. 2009-105007 has not only a function of accommodating the battery cell, but also another function such as a function of connecting components together or a function of inserting a component into another component. Since these functions are provided in separate components, the number of components of the housing is large.

Further, when the housing described in each of Japanese Patent Laying-Open No. 2009-105007 and the specification of Chinese Utility Model No. 208189687 is constituted of a plurality of components, the components are joined together through a joining portion. When providing this joining portion, a clearance for forming the joining portion is provided around the joining portion. Since it is necessary to increase the size of the housing by a size corresponding to the provided clearance, the energy density of the battery pack is decreased.

The present technology has been made to solve the above-described problem and has an object to provide a battery pack having an improved energy density and a necessary function while reducing the number of components.

The present technology provides the following battery pack.
[1]
A battery pack comprising:
a stack in which a plurality of battery cells are stacked along a first direction, each of the plurality of battery cells having a prismatic shape including an upper surface, a bottom surface facing the upper surface, and a side surface located between the upper surface and the bottom surface; and
a housing in which a bottom portion facing the bottom surface and a side wall portion facing the side surface are formed in one piece, wherein
the bottom portion includes a cooling mechanism that is able to cool the stack, and
the side wall portion includes a shock absorbing mechanism.
[2]
The battery pack according to [1], wherein the cooling mechanism includes a cooling medium path provided inside the bottom portion, the cooling medium path being a path through which a cooling medium is able to flow.
[3]
The battery pack according to [2], wherein the cooling medium path is disposed to overlap with both the stack and the side wall portion when viewed in a second direction in which the upper surface and the bottom surface face each other.
[4]
The battery pack according to any one of [1] to [3], wherein
an inner space is provided in the side wall portion,
the side wall portion has a rib disposed in the inner space to partition the inner space into a plurality of regions, and the shock absorbing mechanism is constituted of the inner space and the rib.
[5]
The battery pack according to any one of [1] to [4], wherein the side wall portion faces a battery cell of the plurality of battery cells located at an end portion in the first direction.
[6]
The battery pack according to any one of [1] to [5], wherein
the side surface includes a first side surface portion and a second side surface portion disposed to face each other in a third direction orthogonal to the first direction,
the bottom surface includes a first portion located on the first side surface portion side with respect to a center of the bottom surface, and a second portion located on the second side surface portion side with respect to the center,
the housing includes
   a first housing member in which a first bottom portion facing the first portion and a first side wall portion disposed to face the first side surface portion are formed in one piece, and
   a second housing member in which a second bottom portion facing the second portion and a second side wall portion disposed to face the second side surface portion are formed in one piece, and
respective end portions of the first bottom portion of the first housing member and the second bottom portion of the second housing member are joined to each other.
[7]
The battery pack according to [6], wherein each of the first housing member and the second housing member is formed by extrusion molding.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a configuration of a battery pack according to a first embodiment of the present technology.

FIG. 2 is a perspective view showing a configuration of each of battery cells and separators according to the first embodiment of the present technology.

FIG. 3 is a perspective view showing the configuration of each battery cell according to the first embodiment of the present technology.

FIG. 4 is a cross sectional view of the battery pack of FIG. 1 when viewed in a direction of a line with arrows IV-W.

FIG. 5 is a cross sectional view showing a configuration of a battery pack according to a comparative example.

FIG. 6 is a cross sectional view showing a configuration of a battery pack according to a second embodiment of the present technology.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include other batteries such as a nickel-metal hydride battery and a sodium ion battery. In the present specification, the term “electrode” may collectively represent a positive electrode and a negative electrode.

The “battery pack” can be mounted on vehicles such as a hybrid electric vehicle (BEV), a plug-in hybrid electric vehicle (PHEV), and a battery electric vehicle (BEV). It should be noted that the use of the “battery pack” is not limited to the use in a vehicle.

It should be noted that in each of the figures, a Y direction serving as a first direction is defined as a direction in which a plurality of battery cells are stacked, a Z direction serving as a second direction is defined as a direction in which an upper surface and a bottom surface of each battery cell face each other, and an X direction serving as a third direction is defined as a direction in which a first side surface portion and a second side surface portion of the battery cell face each other.

### First Embodiment

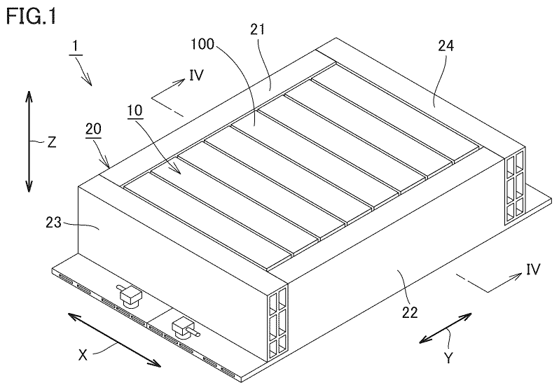

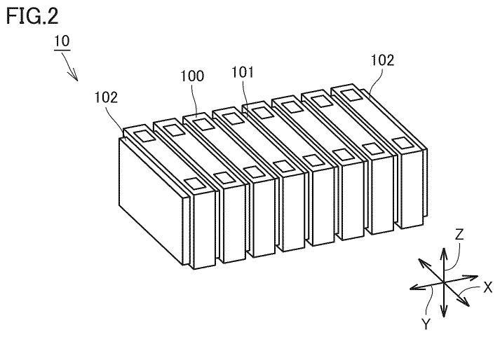

FIG. 1 is a perspective view showing a configuration of a battery pack according to a first embodiment of the present technology. FIG. 2 is a perspective view showing a configuration of each of battery cells and separators according to the first embodiment of the present technology.

As shown in FIGS. 1 and 2, a battery pack 1 according to the first embodiment of the present technology includes a stack 10 and a housing 20. Stack 10 includes a plurality of battery cells 100, inter-cell separators 101, and end separators 102. The plurality of battery cells 100 are stacked along the first direction (Y direction). The plurality of battery cells 100 in the present embodiment are stacked along the first direction (Y direction) with each inter-cell separator 101 being interposed between battery cells 100. Each of inter-cell separators 101 is a plate having an insulating property.

Each of end separators 102 is a plate having an insulating property. End separators 102 are respectively provided to be located at both ends of stack 10 in the first direction (Y direction). The plurality of battery cells 100 are sandwiched between end separators 102 in the first direction (Y direction).

Housing 20 accommodates stack 10. Housing 20 is composed of aluminum or steel, for example. Housing 20 in the present embodiment is constituted of five components. Housing 20 includes a first housing member 21, a second housing member 22, a third housing member 23, a fourth housing member 24, and a cover member (not shown).

First to fourth housing members 21 to 24 are joined together at positions at which they are in contact. The cover member is provided on first to fourth housing members 21 to 24 so as to cover stack 10 from above.

Housing 20 restrains stack 10 in the first direction (Y direction). In the present embodiment, stack 10 is sandwiched between third housing member 23 and fourth housing member 24 of housing 20 in the first direction (Y direction) and is accordingly restrained.

Stacked battery cells 100 are inserted into housing 20 with a compressive force in the first direction (Y direction) being applied to stacked battery cells 100 and then the compressive force is released, with the result that a tensile force is applied to first housing member 21 and second housing member 22 that each connect between third housing member 23 and fourth housing member 24. As a reaction thereto, first housing member 21 and second housing member 22 press third housing member 23 and fourth housing member 24 in directions of bringing them closer to each other. As a result, housing 20 restrains stack 10 in the Y direction. It should be noted that other configurations of housing 20 will be described later.

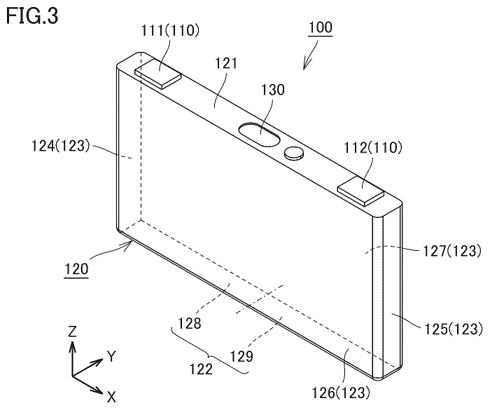

FIG. 3 is a perspective view showing the configuration of each battery cell according to the first embodiment of the present technology. As shown in FIG. 3, battery cell 100 is, for example, a lithium ion battery. Battery cell 100 has a prismatic shape.

Battery cell 100 according to the present embodiment has electrode terminals 110, a case body 120, and a gas-discharge valve 130.

Electrode terminal 110 is formed on case body 120. Electrode terminals 110 have a positive electrode terminal 111 and a negative electrode terminal 112 as two electrode terminals 110 arranged side by side along the third direction (X direction).

Case body 120 has a rectangular parallelepiped shape, and forms the external appearance of battery cell 100. An electrode assembly (not shown) and an electrolyte solution (not shown) are accommodated in case body 120.

Case body 120 has an upper surface 121, a bottom surface 122, and a side surface 123. Upper surface 121 is a flat surface orthogonal to the Z direction. Electrode terminals 110 are provided on upper surface 121. Bottom surface 122 faces upper surface 121 along the second direction (Z axis direction). Side surface 123 is located between upper surface 121 and bottom surface 122.

Side surface 123 includes a first side surface portion 124, a second side surface portion 125, a third side surface portion 126, and a fourth side surface portion 127.

First side surface portion 124 and second side surface portion 125 are disposed to face each other in the third direction (X direction) orthogonal to the first direction (Y direction). Each of first side surface portion 124 and second side surface portion 125 has a rectangular shape in which the Z direction corresponds to the long-side direction and the Y direction corresponds to the short-side direction when viewed in the X direction.

Each of third side surface portion 126 and fourth side surface portion 127 is constituted of a flat surface orthogonal to the Y direction. Each of third side surface portion 126 and fourth side surface portion 127 has the largest area among the areas of the plurality of side surfaces of case body 120. Each of third side surface portion 126 and fourth side surface portion 127 has a rectangular shape in which the X direction corresponds to the long-side direction and the Z direction corresponds to the short-side direction when viewed in the Y direction.

Bottom surface 122 has a first portion 128 and a second portion 129. First portion 128 is located on the first side surface portion 124 side with respect to the center of bottom surface 122. Second portion 129 is located on the second side surface portion 125 side with respect to the center of bottom surface 122.

The plurality of battery cells 100 are stacked such that third side surface portions 126 of battery cells 100, 100 adjacent to each other in the Y direction face each other and fourth side surface portions 127 of battery cells 100, 100 adjacent to each other in the Y direction face each other. Thus, positive electrode terminals 111 and negative electrode terminals 112 are alternately arranged in the Y direction in which the plurality of battery cells 100 are stacked.

Gas-discharge valve 130 is provided in upper surface 121. When internal pressure of case body 120 becomes more than or equal to a predetermined value due to gas generated inside case body 120, gas-discharge valve 130 discharges the gas to outside of case body 120.

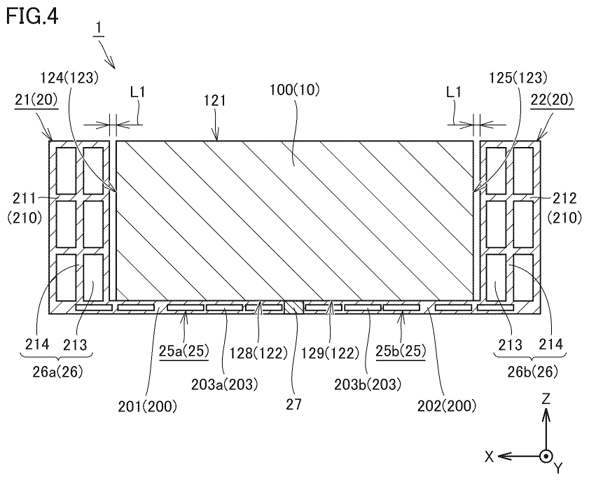

FIG. 4 is a cross sectional view of the battery pack of FIG. 1 when viewed in a direction of a line with arrows IV-IV. As shown in FIG. 4, housing 20 includes a bottom portion 200 and a side wall portion 210.

In the present embodiment, each of first housing member 21 and second housing member 22 of housing 20 includes a bottom portion 200 and a side wall portion 210. Specifically, first housing member 21 has a first bottom portion 201 and a first side wall portion 211. Second housing member 22 has a second bottom portion 202 and a second side wall portion 212.

Bottom portion 200 faces bottom surface 122 of battery cell 100. In the present embodiment, first bottom portion 201 faces first portion 128. Second bottom portion 202 faces second portion 129.

Side wall portion 210 faces side surface 123 of battery cell 100. In the present embodiment, first side wall portion 211 faces first side surface portion 124. Second side wall portion 212 faces second side surface portion 125.

In housing 20, bottom portion 200 and side wall portion 210 are formed in one piece. In the present embodiment, in first housing member 21, first bottom portion 201 and first side wall portion 211 are formed in one piece. In second housing member 22, second bottom portion 202 and second side wall portion 212 are formed in one piece.

Each of first housing member 21 and second housing member 22 is formed by extrusion molding. It should be noted that each of first housing member 21 and second housing member 22 is not limited to being formed by extrusion molding, and may be formed by casting or the like.

Respective end portions of first bottom portion 201 of first housing member 21 and second bottom portion 202 of second housing member 22 are joined to each other. Thus, a connection portion 27 is formed between first bottom portion 201 and second bottom portion 202. Connection portion 27 is formed by friction stir welding, for example. It should be noted that connection portion 27 may be formed by other joining such as arc welding.

Bottom portion 200 includes a cooling mechanism 25 that can cool stack 10. Cooling mechanism 25 is provided inside bottom portion 200. In the present embodiment, one cooling mechanism 25a is provided inside first bottom portion 201. The other cooling mechanism 25b is provided inside second bottom portion 202.

Cooling mechanism 25 includes cooling medium paths 203 through each of which a cooling medium can flow. The plurality of cooling medium paths 203 are provided in bottom portion 200 at intervals. In the present embodiment, cooling medium paths 203a are located inside first bottom portion 201. The other cooling medium paths 203b are located in second bottom portion 202.

Cooling medium paths 203 are disposed to overlap with both stack 10 and side wall portion 210 when viewed in the second direction (Z direction) in which upper surface 121 and bottom surface 122 face each other. The cooling medium flowing through each of cooling medium paths 203 is, for example, cooling water.

If bottom portion 200 and side wall portion 210 are joined together by welding or the like, any other component such as the cooling mechanism is not disposed in surroundings therearound in order to reduce an influence of the joining. In this case, the surroundings around bottom portion 200 and side wall portion 210 joined together include a portion of bottom portion 200 at a position overlapping with side wall portion 210 when viewed in the second direction (Z direction). Therefore, when bottom portion 200 and side wall portion 210 are joined together, any other component such as the cooling mechanism is not disposed in the portion of bottom portion 200 at the position overlapping with side wall portion 210 when viewed in the second direction (Z direction).

On the other hand, since bottom portion 200 and side wall portion 210 are formed in one piece in housing 20 according to the present embodiment, bottom portion 200 and side wall portion 210 are not joined together by welding or the like. Therefore, cooling mechanism 25 can be disposed in the portion of bottom portion 200 at the position overlapping with side wall portion 210 when viewed in the second direction (Z direction). Thus, an occupation ratio of cooling medium paths 203 in bottom portion 200 can be improved, with the result that battery cell 100 can be cooled efficiently.

Side wall portion 210 includes shock absorbing mechanisms 26. In the present embodiment, one shock absorbing mechanism 26a is provided in first side wall portion 211, and the other shock absorbing mechanism 26b is provided in second side wall portion 212.

An inner space 213 is provided in side wall portion 210. Side wall portion 210 has a rib 214. Rib 214 is disposed in inner space 213 to partition inner space 213 into a plurality of regions. Thus, shock absorbing mechanism 26 is constituted of inner space 213 and rib 214. When a shock is applied to side wall portion 210 from outside, shock absorbing mechanism 26 is collapsed to absorb energy of the shock, thereby reducing the shock on battery cell 100.

It should be noted that shock absorbing mechanism 26 in the present embodiment is constituted of inner space 213 and rib 214; however, the shock absorbing mechanism is not limited to this configuration. The shock absorbing mechanism may be constructed in the following manner: a member that is more likely to be deformed than the other portions is disposed in a portion of side wall portion 210; or an inner space with no rib therein is formed.

In the third direction (X direction), there is a clearance L1 between battery cell 100 and side wall portion 210. Clearance L1 may have any width as long as it does not interfere with the insertion of battery cell 100 into housing 20. In order to increase the energy density, clearance L1 is preferably narrow.

Hereinafter, a battery pack according to a comparative example for the first embodiment of the present technology will be described. Since the configuration of a housing of the battery pack according to the comparative example is different from that of battery pack 1 according to the first embodiment of the present technology, the same configuration as that of battery pack 1 according to the first embodiment of the present technology will not be described repeatedly.

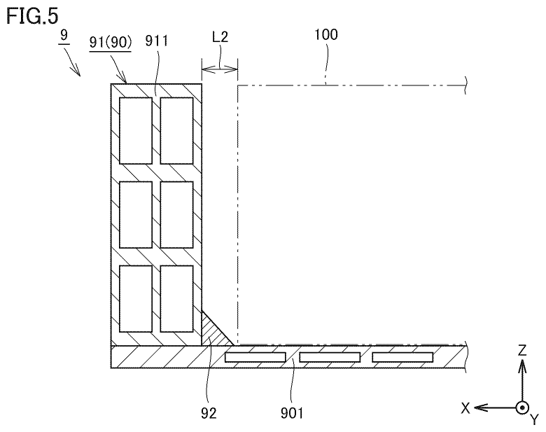

FIG. 5 is a cross sectional view showing the configuration of the battery pack according to the comparative example. It should be noted that only the first housing member is shown in FIG. 5; however, the same structure as that of the first housing member shown in FIG. 5 can be also applied to the second housing member.

As shown in FIG. 5, in a battery pack 9 according to the comparative example, a first bottom portion 901 and a first side wall portion 911 of a first housing member 91 of housing 90 are constituted of separate members. First bottom portion 901 and first side wall portion 911 are joined together by arc welding, for example. A joining portion 92 is formed by the arc welding. Joining portion 92 is formed at a corner portion between first bottom portion 901 and first side wall portion 911.

In this comparative example, since joining portion 92 is elevated from first bottom portion 901 toward the battery cell 100 side, battery cell 100 cannot be disposed immediately above joining portion 92. Therefore, battery cells 100 according to the comparative example need to be disposed with joining portion 92 being avoided. A clearance L2 is formed between battery cell 100 and first side wall portion 911 as a clearance necessary to form joining portion 92 in the comparative example.

On the other hand, in battery pack 1 according to the present embodiment, since first bottom portion 201 and first side wall portion 211 of first housing member 21 are formed in one piece as shown in FIG. 4, no joining portion such as an arc welding portion is formed at a corner portion between first bottom portion 201 and first side wall portion 211. Therefore, clearance L1 according to the present embodiment can be smaller than clearance L2 according to the comparative example. Since clearance L1 is smaller than clearance L2, housing 20 according to the present embodiment can be smaller than that of the comparative example. As a result, an occupation ratio of battery cells 100 in battery pack 1 can be increased to attain an improved energy density of battery pack 1.

In battery pack 1 according to the first embodiment of the present technology, since bottom portion 200 having cooling mechanism 25 and side wall portion 210 having shock absorbing mechanism 26 are formed in one piece to form housing 20, the number of components can be reduced while attaining a necessary function. Further, since bottom portion 200 and side wall portion 210 are formed in one piece, no joining portion needs to be provided between bottom portion 200 and side wall portion 210, with the result that a clearance necessary to form the joining portion does not need to be provided inside housing 20. Thus, the size of housing 20 can be decreased by the size corresponding to the decrease in clearance, with the result that the occupation ratio of battery cells 100 in battery pack 1 can be increased to attain an improved energy density of battery pack 1.

In battery pack 1 according to the first embodiment of the present technology, since housing 20 is formed by forming bottom portion 200 and side wall portion 210 in one piece, the number of components can be reduced as compared with a case where the bottom portion and the side wall portion are not formed in one piece, thus resulting in reduced cost of the battery pack 1.

In battery pack 1 according to the first embodiment of the present technology, since housing 20 is formed by forming bottom portion 200 and side wall portion 210 in one piece, the number of joining positions can be reduced as compared with a case where the bottom portion and the side wall portion are not formed in one piece, with the result that housing 20 can have high strength or high rigidity while avoiding application of load to the joining portion.

In battery pack 1 according to the first embodiment of the present technology, since housing 20 is formed by forming bottom portion 200 and side wall portion 210 in one piece, the number of welded positions can be minimized as compared with the case where the bottom portion and the side wall portion are not formed in one piece, with the result that housing 20 can be suppressed from being changed in shape due to input of heat during the welding.

In battery pack 1 according to the first embodiment of the present technology, since housing 20 is formed by forming bottom portion 200 and side wall portion 210 in one piece, the joining portion between bottom portion 200 and side wall portion 210 can be eliminated as compared with the case where the bottom portion and the side wall portion are not formed in one piece, thus resulting in improved waterproofness of housing 20.

In battery pack 1 according to the first embodiment of the present technology, since cooling mechanism 25 is provided with cooling medium path 203 through which the cooling medium can flow, battery cell 100 can be efficiently cooled.

In battery pack 1 according to the first embodiment of the present technology, since bottom portion 200 and side wall portion 210 are formed in one piece, cooling medium path 203 can be provided immediately below battery cell 100 and immediately below side wall portion 210 in bottom portion 200. As a result, a range in which battery cell 100 can be cooled can be increased in bottom portion 200, with the result that battery cell 100 can be cooled efficiently.

In battery pack 1 according to the first embodiment of the present technology, since shock absorbing mechanism 26 is constituted of inner space 213 and rib 214, inner space 213 in which rib 214 is disposed is collapsed to absorb energy of a shock when the shock is applied to side wall portion 210, thereby reducing the shock on battery cell 100.

In battery pack 1 according to the first embodiment of the present technology, when housing 20 is increased in size, a portion of housing 20 can be constituted of two components to cope with a large-sized battery pack while forming bottom portion 200 and side wall portion 210 in one piece.

In battery pack 1 according to the first embodiment of the present technology, since each of first housing member 21 and second housing member 22 is formed by extrusion molding, the components of housing 20 can be efficiently manufactured.

### Second Embodiment

Hereinafter, a battery pack according to a second embodiment of the present technology will be described. Since the configuration of a housing of the battery pack according to the second embodiment is different from that of battery pack 1 according to the first embodiment of the present technology, the same configuration as that of battery pack 1 according to the first embodiment of the present technology will not be described repeatedly.

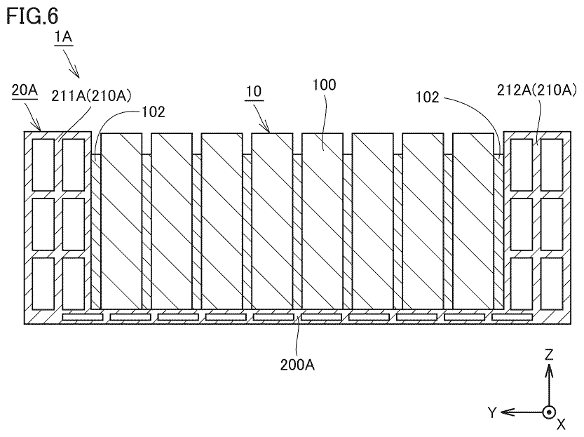

FIG. 6 is a cross sectional view showing the configuration of the battery pack according to the second embodiment of the present technology. As shown in FIG. 6, a housing 20A included in a battery pack 1A according to the second embodiment includes a bottom portion 200A and a side wall portion 210A.

Side wall portion 210A faces a battery cell 100 of the plurality of battery cells 100 located at an end portion in the first direction (Y direction). In the present embodiment, side wall portion 210A faces battery cell 100 with end separator 102 being interposed therebetween.

A first side wall portion 211A and a second side wall portion 212A are disposed to sandwich stack 10, which is the plurality of battery cells 100, in the first direction (Y direction). Housing 20A restrains stack 10 in the first direction (Y direction) by first side wall portion 211A and second side wall portion 212A. Each of first side wall portion 211A and second side wall portion 212A is formed in one piece with bottom portion 200A.

In battery pack 1A according to the second embodiment of the present technology, since bottom portion 200A and side wall portion 210A are formed in one piece, housing 20A has high strength or high rigidity as compared with a case where a joining portion is provided between the bottom portion and the side wall portion. Since side wall portion 210A is disposed to face battery cell 100 of the plurality of battery cells 100 located at the end portion in the first direction (Y direction), expansion of battery cell 100 in the first direction (Y direction) can be received by housing 20A.

It should be noted that in each of the embodiments described above, each electrode terminal is provided on the upper surface of the battery cell; however, it is not limited to this configuration. The electrode terminal may be provided on the side surface of the battery cell. When the electrode terminal is provided on the side surface of the battery cell, a clearance is provided between the side surface of the battery cell and the housing in order to secure a space for disposing the electrode terminal.

Although the embodiments of the present invention have been described and illustrated in detail, it is clearly understood that the same is by way of illustration and example only and is not to be taken by way of limitation, the scope of the present invention being interpreted by the terms of the appended claims. The scope of the present invention is defined by the terms of the claims, and is intended to include any modifications within the scope and meaning equivalent to the terms of the claims.

What is claimed is:

1. A battery pack comprising:
a stack in which a plurality of battery cells are stacked along a first direction, each of the plurality of battery cells having a prismatic shape including an upper surface, a bottom surface facing the upper surface, and a side surface located between the upper surface and the bottom surface; and
a housing in which a bottom portion facing the bottom surface and a side wall portion facing the side surface are formed in one piece, wherein
the bottom portion includes a cooling mechanism that is able to cool the stack, and
the side wall portion includes a shock absorbing mechanism.

2. The battery pack according to claim 1, wherein the cooling mechanism includes a cooling medium path provided inside the bottom portion, the cooling medium path being a path through which a cooling medium is able to flow.

3. The battery pack according to claim 2, wherein the cooling medium path is disposed to overlap with both the stack and the side wall portion when viewed in a second direction in which the upper surface and the bottom surface face each other.

4. The battery pack according to claim 1, wherein
an inner space is provided in the side wall portion,
the side wall portion has a rib disposed in the inner space to partition the inner space into a plurality of regions, and
the shock absorbing mechanism is constituted of the inner space and the rib.

5. The battery pack according to claim 2, wherein
an inner space is provided in the side wall portion,
the side wall portion has a rib disposed in the inner space to partition the inner space into a plurality of regions, and
the shock absorbing mechanism is constituted of the inner space and the rib.

6. The battery pack according to claim 3, wherein
an inner space is provided in the side wall portion,
the side wall portion has a rib disposed in the inner space to partition the inner space into a plurality of regions, and
the shock absorbing mechanism is constituted of the inner space and the rib.

7. The battery pack according to claim 1, wherein the side wall portion faces a battery cell of the plurality of battery cells located at an end portion in the first direction.

8. The battery pack according to claim 2, wherein the side wall portion faces a battery cell of the plurality of battery cells located at an end portion in the first direction.

9. The battery pack according to claim 1, wherein
the side surface includes a first side surface portion and a second side surface portion disposed to face each other in a third direction orthogonal to the first direction,
the bottom surface includes a first portion located on the first side surface portion side with respect to a center of the bottom surface, and a second portion located on the second side surface portion side with respect to the center,
the housing includes
a first housing member in which a first bottom portion facing the first portion and a first side wall portion disposed to face the first side surface portion are formed in one piece, and
a second housing member in which a second bottom portion facing the second portion and a second side wall portion disposed to face the second side surface portion are formed in one piece, and
respective end portions of the first bottom portion of the first housing member and the second bottom portion of the second housing member are joined to each other.

10. The battery pack according to claim 2, wherein
the side surface includes a first side surface portion and a second side surface portion disposed to face each other in a third direction orthogonal to the first direction,
the bottom surface includes a first portion located on the first side surface portion side with respect to a center of the bottom surface, and a second portion located on the second side surface portion side with respect to the center,
the housing includes
a first housing member in which a first bottom portion facing the first portion and a first side wall portion disposed to face the first side surface portion are formed in one piece, and
a second housing member in which a second bottom portion facing the second portion and a second side wall portion disposed to face the second side surface portion are formed in one piece, and
respective end portions of the first bottom portion of the first housing member and the second bottom portion of the second housing member are joined to each other.

11. The battery pack according to claim 9, wherein each of the first housing member and the second housing member is formed by extrusion molding.

12. The battery pack according to claim 10, wherein each of the first housing member and the second housing member is formed by extrusion molding.
